(19) United States
(12) Patent Application Publication
(10) Pub. No.: US 2026/0080083 A1
(43) Pub. Date: Mar. 19, 2026

(54) ACCESS CONTROL AND GOVERNANCE FOR DISTRIBUTED DATA

(71) Applicant: Salesforce, Inc., San Francisco, CA (US)

(72) Inventors: Adithya Nittor Vishwanath, Bangalore (IN); Raveendrnathan Loganathan, Sammamish, WA (US); Sudheer Kumar Kanaka, Bangalore (IN); Yanik Grignon, Georgetown, TX (US); Ahmet Ali Akkas, Kirkland, WA (US); Daksha Asrani, Issaquah, WA (US)

(21) Appl. No.: 18/928,542

(22) Filed: Oct. 28, 2024

(30) Foreign Application Priority Data
Sep. 13, 2024 (IN) 202411069437

(51) Int. Cl. G06F 21/62

(52) U.S. Cl. CPC G06F 21/6218; G06F 2221/2113

(57) ABSTRACT

Access control may involve receiving a request from a computing device of a user for access to data available through a computer system, where at least some of the data is stored locally in the computer system. Access control may further involve identifying one or more tags associated with the data, each tag including a metadata label characterizing the data. One or more data governance policies can be determined as being applicable to the request based on the identified tags and further based on one or more attributes of the request. The one or more data governance policies can be applied to derive filtered data for output to the user's computing device in response to the request. In some implementations, the computer system includes a cloud-based datastore and is configured to automatically assign or recommend tags for incoming data from remote computer systems.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in its entirety and for all purposes.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to access control, more specifically to techniques for applying access control policies and other data governance policies to requests for access to electronic data.

### BACKGROUND

In a distributed computing environment, electronic data may be collected from different data sources and stored in a computer system for access by users. Data can have different formats and may be structured (e.g., entries from a relational database) or unstructured (e.g., a file with content not conforming to a predefined data model or database schema). Managing access to and securing data from diverse sources can be challenging from an access control and data governance standpoint. The collected data may be subject to any number of rules governing who is permitted to access a particular piece of data and the way in which the data is accessed. Such rules can include regulatory standards imposed by government or industry bodies as well as rules specified by entities that own or control the data. The computer system may be expected to enforce these rules throughout the data lifecycle, for example, during creation, subsequent modification, and utilization of the data. Effective data governance is important not only for ensuring compliance with regulations but also for maintaining data integrity and data security.

### BRIEF DESCRIPTION OF THE DRAWINGS

FIG. 1 shows an example of a computing environment incorporating certain aspects of the present disclosure.

FIG. 2 shows an example implementation of a computer system with tagging capabilities.

FIG. 3 illustrates relationships between governance policies, tags, and data resources in a computer system configured according to certain implementations.

FIG. 4 shows an example of a process for assigning tags to data, according to certain implementations.

FIG. 5A shows examples of tag hierarchies.

FIG. 5B shows an example of tag classifications.

FIG. 6 shows an example of a data object and a masking policy applied to that data object, according to certain implementations.

FIGS. 7A-7C show examples of access control policies, according to certain implementations.

FIG. 8 illustrates a process for handling an access request, according to certain implementations.

FIG. 9 shows an example of governance policies applied at different levels of a data stack, according to certain implementations.

FIG. 10 is a flow diagram of an example method for providing access control over data, according to certain implementations.

FIG. 11A shows a system diagram illustrating architectural components of an applicable environment in which implementations enabled by the present disclosure may be practiced.

FIG. 11B shows a system diagram further illustrating architectural components of an applicable environment in which implementations enabled by the present disclosure may be practiced.

FIG. 12 shows a system diagram illustrating the architecture of a multi-tenant database environment in which implementations enabled by the present disclosure may be practiced.

FIG. 13 shows a system diagram further illustrating the architecture of a multi-tenant database environment, according to certain implementations.

### DETAILED DESCRIPTION

Examples of systems, apparatus, and methods for access control and governance over data in a distributed computing environment are disclosed herein. The described subject matter may be implemented in the context of a computer-implemented system, such as a software-based system, a database system, a multi-tenant environment, and/or the like. Moreover, the described subject matter may be implemented in connection with two or more separate and distinct computer-implemented systems that cooperate and communicate with one another. One or more examples may be implemented in numerous ways, including as a process, an apparatus, a system, a device, a method, a computer-readable medium such as a computer-readable storage medium containing computer-readable instructions or computer program code, or as a computer program product comprising a storage medium having program code stored therein.

In some implementations, data from remote computer systems may be collected for storage in a central computer system. The central computer system may operate a data cloud (e.g., using one or more cloud servers). The data stored in the data cloud may be labeled with metadata tags. For example, one or more tags may be assigned to incoming data when the data arrives from a remote computer system. The central computer system may include an access control system configured to evaluate data governance policies associated with the tags to determine whether to allow user access to data. Examples of governance policies include access control (e.g., authorization) policies, data masking policies, and data retention policies.

Each policy may include one or more rules (e.g., a rule for determining whether to allow access to data, or a rule for determining whether to mask/redact a specific data field within a data object). A policy rule may specify how one or more tags and/or one or more inherent properties of a data object (e.g., dataset size) are to be processed as part of making an access decision. Other types of information a policy rule may potentially consider include contextual information regarding an access request, for example, an identity of a user making the access request or a time associated with the access request. Accordingly, in some implementations, the access control system may be an attribute-based access control (ABAC) system that evaluates rules based on attributes of entities, attributes of data resources, and attributes of the computing environment to make a context-specific access decision. A policy rule may reference any number of tags and/or attributes as logical conditions for allowing or disallowing access in the case of an authorization policy, or as logical conditions for performing some other type of action (e.g., data masking). As discussed later below, tags may be applied in a manner that enables the access control system to adapt to new data types or changing access control requirements without constant rule/policy modifications. Such adaptability is beneficial in a rapidly evolving data landscape, as is often the case in a distributed computing environment.

In some implementations, the central computer system may include a data classification system that automatically determines tags for assignment to incoming data.

The data classification system may be integrated into a metadata annotation framework of the central computer system and may be configured to categorize data based on sensitivity (e.g., whether data constitutes personally identifiable information (PII) or medical records), intended usage, and/or other attributes to generate tags for use by the access control system. Tags provide a convenient mechanism for authoring and enforcing governance policies, for example, creation of a new policy in connection with compliance adherence, risk management, or security incident (e.g., data breach) response. In some implementations, tags may be carried over automatically (e.g., inherited based on lineage) across different levels of a data hierarchy and/or across different levels of a hierarchical tagging schema.

In some implementations, the data classification system may be configured to recommend and/or automatically assign tags for incoming data. For example, the data classification system may include one or more static classifiers in addition to a generative artificial intelligence (AI) model. The static classifier(s) may be implemented using a machine learning (ML) model and/or a deterministic algorithm (e.g., pattern recognition using regular expressions). The ML model can be trained through supervised learning on sample data that has been pre-labeled with tags. The static classifier(s) can output a set of one or more initial tags for input to the generative AI model. The generative AI model may receive additional tags as input (e.g., tags for new data types not represented in the sample data used for training) and may refine or augment the set of initial tags to generate a final set of tags for the incoming data.

Data classification plays an important role in a variety of use cases, each of which may benefit from the tag-based techniques disclosed herein. Examples of potential use cases include:
Data Protection: Identifying and protecting sensitive data across its lifecycle.
Risk Management: Managing access controls and reducing data breach risks.
Data Retention: Enforcing data retention policies based on classification.
Data Usage in AI Models: Classifying data to monitor and mitigate biases in AI/ML models.
Compliance: Adhering to regulatory requirements by identifying relevant data.
Data Quality: Maintaining data quality for improved analytics and decision-making.
Policy Management: Basis for governance and privacy policies.
Incident Response: Efficiently identifying compromised data in breaches.

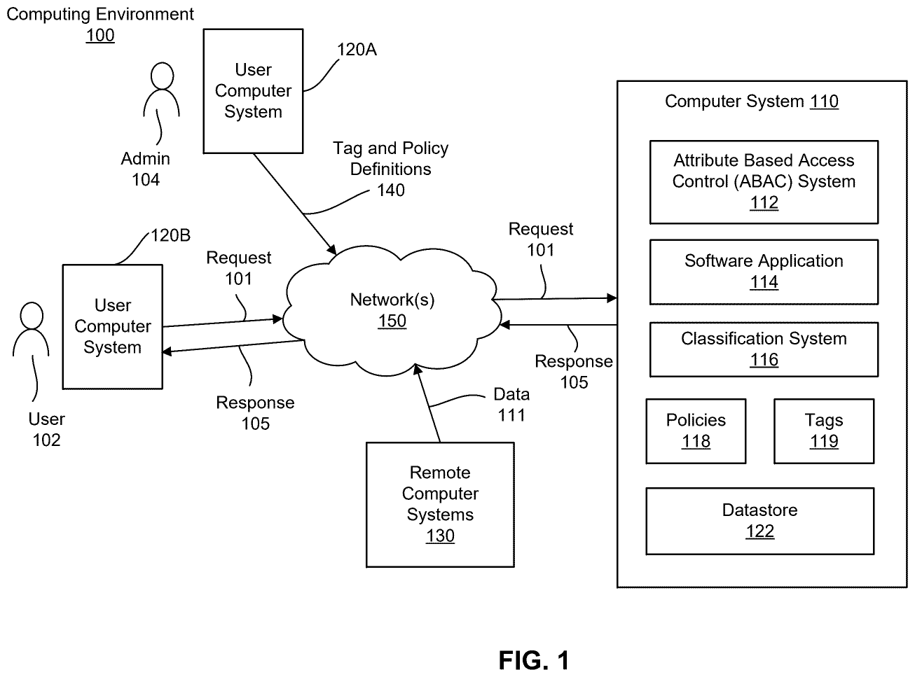

FIG. 1 shows an example of a computing environment 100 incorporating certain aspects of the present disclosure. The environment 100 includes a computer system 110, one or more remote computer systems 130, and user computer systems 120. A first user computer system 120A may be operated by an administrator (admin) 104. A second user computer system 120B may be operated by a user 102.

Computer system 110 may be configured as a central computer system that makes data available to users. For instance, the user 102 may submit a request 101 for access to data using the user computer system 120B. The request 101 can be sent to the computer system 110 through one or more network(s) 150 that communicatively couple the various systems in the computing environment 100. The request 101 may specify an action to perform (e.g., read/write/delete) with respect to data residing in a datastore 122 of the computer system 110. In some instances, some or all the data identified in the request 101 may be stored externally (e.g., in one of the remote computer systems 130). In such instances, the computer system 110 may obtain the requested data from the external data source(s) as part of responding to the request 101.

Admin 104 may be a user who configures access rules for the user 102 and/or other users who access data through the computer system 110. The admin 104 may create tag and policy definitions 140, which can include one or more tags and one or more policies (e.g., an access control policy) containing rules that reference the tags defined by the admin 104.

The computer system 110 may also be configured with predefined tags and policies (e.g., a default or mandatory access control policy).

Computer system 110 may include an ABAC system 112, a software application 114, and a classification system 116. The computer system 110 may further include a memory subsystem that stores policies 118 and tags 119. The memory subsystem can include one or more storage devices implementing the datastore 122. The datastore 122 may be configured to store data obtained from the remote computer system(s) 130. At any given time, the computer system 110 may be receiving data from any number of sources for storage in the datastore 122.

Policies 118 can include one or more data governance policies that apply to data in the datastore 122. For example, the policies 118 may include one or more access control policies, one or more masking policies, and one or more data retention policies. Policies can be updated over time. New policies can also be created (e.g., by the admin 104). Some policies may be default or mandatory policies defined based on regulations. Other policies may be user-configured by data owners (e.g., an administrator of a company where user 102 is employed). Policies 118 can be digital policies that are defined programmatically. For instance, in some implementations, policy definitions may be written in YAML or in an open-source policy language.

Tags 119 can be used to search, filter, and organize data maintained by the computer system 110, including data stored in the datastore 122. The tags 119 may include default or predefined tags that the computer system 110 makes available to policy writers (e.g., admin 104). Tags 119 may also include custom-defined tags created by administrative users (e.g., the tags from the tag and policy definitions 140). Tags 119 may therefore correspond to a complete set of tags available to be assigned to data objects or other data resources.

In some implementations, the tags 119 may include global/shared tags and client-specific tags. Global tags are tags that can be assigned to data irrespective of who owns or controls the data. Client-specific tags are restricted to being assigned to data owned or controlled by certain entities. For example, in a multi-tenant environment, the datastore 122 can maintain separate datasets for different organizations that subscribe to a cloud storage service provided by the computer system 110. Each dataset may have a corresponding set of tag definitions, with some tags being unique to the dataset (i.e., not applicable to datasets of other tenants). Thus, the user 102 and the admin 104 could be employees of a first tenant serviced by the computer system 110, and the tag and policy definitions 140 may apply to data stored on behalf of the first tenant.

Each tag can include a descriptive label (e.g., a text string) for a data attribute. A tag can serve as an identifier or a categorizer. For example, a tag may be assigned to all or a portion (e.g., a specific field) of a data object to indicate that the data object includes personally identifiable information (e.g., a person's name) or that the data object includes a specific type of information (e.g., that a field represents an email address). Accordingly, tags can indicate the meaning or semantic significance of data and act as supplemental metadata on top of any inherent properties that a data object may possess (e.g., a field-type property indicating a text field). In some implementations, assigned tags may be stored together with their corresponding data resources in the datastore 122 (e.g., as part of a data object itself). Alternatively, the computer system 110 can maintain a separate record of associations between tags and their corresponding data resources.

ABAC system 112 is configured to process the request 101 to determine whether to grant access to data in the datastore 122 and may return a response 105 through the software application 114. The software application 114 can be any application configured to make data available to a user (e.g., the user 102). For example, the software application 114 may include one or more web-based programs configured to provide customer relationship management (CRM), company-internal knowledge base, group messaging, and/or other enterprise functionality to tenant-organizations that subscribe to services provided by the computer system 110. In some implementations, the application 114 may provide a user interface through which a user can specify filter or search criteria to create customized views of data. The user interface may be presented through a client application running on the user's computer system. For example, the user 102 may request that the computer system 110 generate a custom table for display in a web browser of the user computer system 120B, where the custom table includes a subset of fields from a particular data object, and where the subset of fields is arranged in a user-specified order. The computer system 110 may generate the custom table dynamically by populating the custom table with data from a most recent version of the data object.

In some implementations, the computer system 110 may be communicatively coupled to more than one channel through which access requests are received. For example, there may be other applications that access the datastore 122 besides the software application 114, and not all of these applications may be local to the computer system 110. Thus, the ABAC system 112 could include multiple application programming interfaces (APIs) through which requests are received. In general, the ABAC system 112 can be implemented using components corresponding to policy enforcement points, where each enforcement point is configured to enforce the policies 118 with respect to requests arriving at the enforcement point.

In some implementations, the ABAC system 112 may resolve conflicts between access control policies through evaluating policies in the following order of precedence:
1. if any “disallow” policy returns “True,” access is denied;
2. else, if any “allow” policy returns “True,” access is granted;
3. and if neither policy type is satisfied, access is denied by default.

Classification system 116 includes one or more classifier units configured to determine tags for assignment to data existing or to be stored in the datastore 122. For instance, the classifier unit(s) may automatically assign tags and/or recommend tags for incoming data so that the tags are stored concurrently with the data.

Datastore 122 is configured to provide persistent storage for data. In some implementations, the datastore 122 may be configured as a cloud-based repository having a data lake architecture. A data lake is a centralized repository designed to store large amounts of structured, semi-structured, or unstructured data. Dake lakes generally employ a flat architecture that allows data to be stored without conforming the data to a predefined database schema. The datastore 122 may store data in its native format (e.g., as received from a data source). Alternatively or additionally, at least some of the data received from an data source may be stored in a format specific to the datastore 122. For example, the datastore 122 may be configured to store data as data lake objects (DLOs) and data model objects (DMOs). DLOs and DMOs may be structured as column-formatted objects in which columns correspond to individual data fields. DLOs operate as containers for structured data or unstructured data. In some instances, a DLO may include metadata pointing to data residing in an external data source (e.g., in one of the remote computer systems 130). DMOs are higher level groupings of data and are often used to create a comprehensive view of related data from different sources. For example, a DMO may include a mix of publicly accessible and secured data from different remote computer systems 130. A DMO can have one or more DLOs mapped to it.

The datastore 122 can be accessed through submitting queries written in structured query language (SQL) or some other query language. These queries may originate from access requests received by the computer system 110. For example, the request 101 may include a SQL query generated by a client application running on the user computer system 120B. Alternatively, the software application 114 may generate the SQL query based on the request 101. The SQL query may be based on one or more parameters specified by the user 102. For example, the user 102 may specify which fields of a data object to view or the order in which the fields are to be displayed. In some instances, the ABAC system 112 may modify a query based on the result of a policy evaluation, e.g., to filter the data so that only a portion of the requested data is returned to the user.

The ABAC system 112 may identify any tags assigned to the data that is the subject of the request 101 and evaluate one or more policies 118 that reference those tags. Depending on the result of the evaluation, the response 105 may indicate that the user has been granted access to the requested data or denied access. In some instances, the response may include filtered data that has been filtered according to the user's request and/or according to a policy that was evaluated. For example, the filtered data may correspond to a redacted version of the data in the datastore 122, where one or more fields are redacted based on a masking policy. As another example, the filtered data may reflect the omission of one or more fields based on an access control policy (e.g., a field that the user 102 is not permitted to view). Thus, the data in the datastore 122 may be transformed based on real-time evaluation of one or more policies to generate a view of the data specifically for the request 101 (e.g., taking into consideration tags along with attributes of the request 101 such as user role, user location, type of access (read/write/modify, etc.), and/or other attributes.

Accordingly, the computer system 110 may ingest data from multiple sources, including remote computer systems 130 controlled or operated by entities other than the entity operating the computer system 110. The ingested data can then be transformed and aggregated to produce high-value derived data for access by users. As the data gets ingested, new metadata may get created to inform these transformations and describe the resulting data. Multiple modes of engagement (e.g., the software application 114) can be formed around the data to provide diverse user experiences across a wide range of use cases. To secure the data across different modes of engagement, the computer system 110 may provide a tag-based mechanism for defining coarse or fine-grained data governance policies (e.g., for compliance and business rules enforcement purposes), and these policies can be applied transparently irrespective of the user system accessing the data. Further, as explained below, use of a tag-based metadata annotation framework may enable policies to be authored with ease, efficiency, and at scale such that the policies can be applied generically to any data space aware data or metadata.

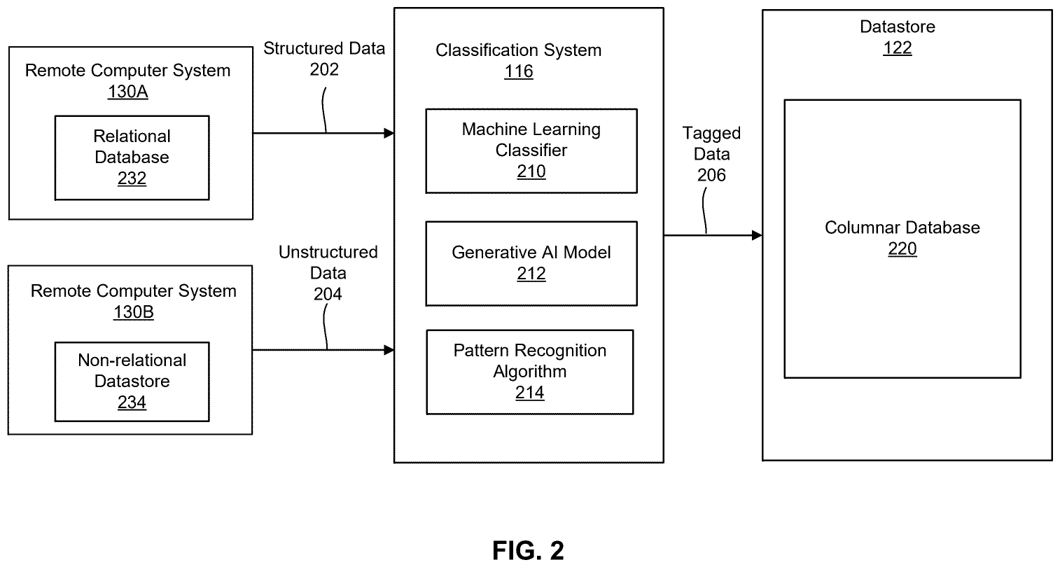

FIG. 2 shows an example implementation of the computer system 110. In the example of FIG. 2, the datastore 122 includes a columnar database 220, and the classification system 116 includes an ML classifier 210, a generative AI model 212, and a pattern recognition algorithm 214. The incoming data to the computer system 110 (e.g., data 111 in FIG. 1) may originate from multiple data sources. At any given time, the computer system 110 may be receiving data from any number of sources for storage in the datastore 122. In some instances, the data may be arriving contemporaneously with a user's access request (e.g., the request 101). For example, the data identified in the request 101 may include data this is generated in real time (e.g., a live stream) by a remote computer system 130. Thus, the data being accessed is not necessarily stored in the datastore 122 in advance of the request 101.

By way of example, the data received by the computer system 110 may include structured data 202 and unstructured data 204. The structured data 202 may be stored in a relational database 232 of a first remote computer system 130A. The unstructured data 204 may be stored in a non-relational datastore 234 of a second remote computer system 130B. The data 202, 204 may be transmitted to the computer system 110 in a variety of ways and in response to various events or trigger conditions. Transmission can be initiated by either the computer system 110 or a remote computer system 130.

Classification system 116 may process the data 202, 204 to generate tagged data 206 for storage in the columnar database 220. The processing performed by the classification system 116 may include assigning tags to the data and placing the tagged data 206 into the columnar database 220 (e.g., as DLOs and DMOs). The tags can be determined using any of the illustrated classifier units, including ML classifier 210, generative AI model 212, pattern recognition algorithm 214, or a combination thereof. In some implementations, the classification system 116 may be configured to recommend policies for the data 202, 204. For example, after determining the tags for a particular data object, the classification system 116 may recommend one or more of the policies 118 based on existing associations between the one or more policies and the determined tags.

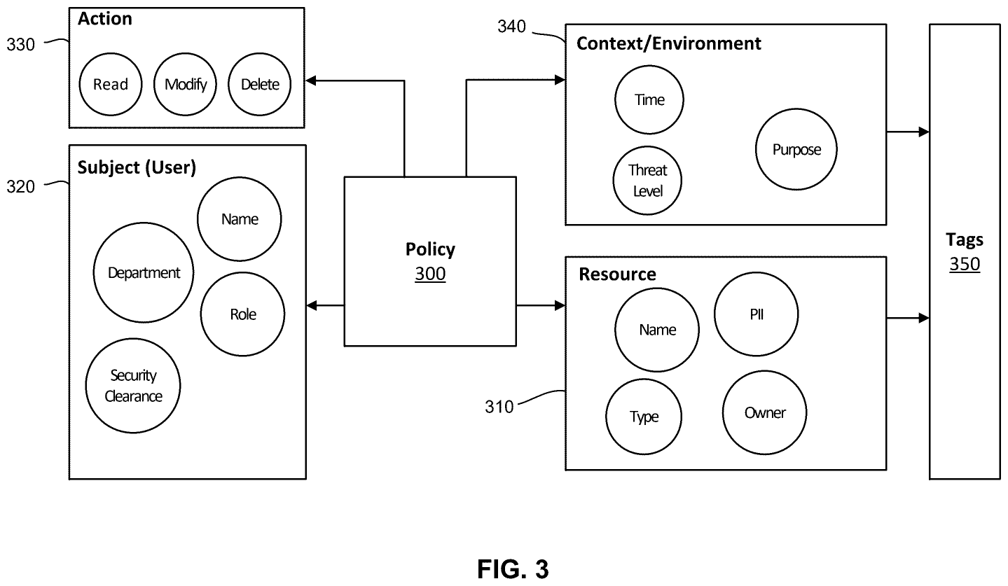

FIG. 3 illustrates relationships between governance policies, tags, and data resources in a computer system configured according to certain implementations. In FIG. 3, a policy 300 is evaluated using tags 350 to determine actions to execute. Such actions may include, for example, granting permission to access data or modifying data through masking. Data resources may be arranged in a hierarchy (e.g., data spaces, data objects within data spaces, and rows or columns within data objects). As such, tags may be applied at various levels of granularity and follow the lineage of data resources. For instance, if a data space is tagged as “GDPR regulated” to indicate that the data space is governed by the General Data Protection Regulation of the European Union, all subordinate resources (e.g., every data object belonging to the data space) may inherit the “GDPR regulated” tag.

FIG. 3 also shows that tags are not limited to being assigned to data resources but may also be applied to attributes associated with an access request. For example, the tags 350 may represent resource attributes 310, user attributes 320, action attributes 330, and/or environmental attributes 340. Resource attributes 310 may include data classifications (e.g., whether a data resource contains PII) and inherent properties such as resource name (e.g., the name of a data space or data object), data type (e.g., object type or field type), and resource owner.

The attributes used in evaluating a policy may originate from the user associated with the access request (e.g., user 102), from a data resource (e.g., a DLO/DMO, or a column or row within the DLO/DMO), and/or from the computing environment. For example, user attributes 320 may include username, user role, department, security clearance level, etc. Another attribute which originates from a user is the action being requested to be performed with respect to the data. For example, action attributes 330 may include read, modify, or delete.

Environmental attributes 340 represent the context surrounding an access request. Examples of environmental attributes include time (e.g., time of day or calendar date), purpose (e.g., a reason for the access request), and threat level (e.g., whether the access request is coming from a high-risk computer system or geographic location).

Accordingly, tags can be assigned to other sources of metadata besides data resources (e.g., a label describing an environmental attribute). A policy may therefore include one or more rules that take into consideration user metadata, environment metadata, data resource metadata, or any combination thereof, with each of these types of metadata being represented by tags. However, unlike the tags assigned to data in the datastore 122, tags for other metadata sources are not necessarily recorded independently of access requests. Instead, the computer system 110 may simply determine these additional tags at the time of an access request, based on the content of the access request or information available to the computer system 110. For example, a user's role may be stored as part of a user profile maintained by the computer system 110, but environmental attributes such as time and threat level may be determined on a per-request basis.

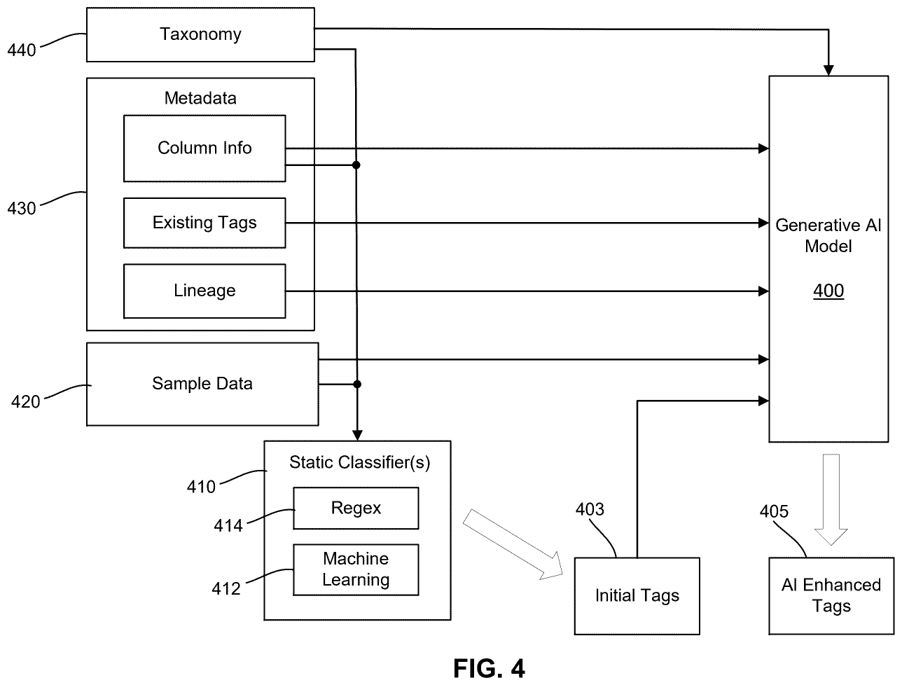

FIG. 4 shows an example of a process for assigning tags to data, according to certain implementations. The process in FIG. 4 involves a generative AI model 400 (e.g., the generative AI model 212 of FIG. 2) and one or more static classifiers 410. The static classifier(s) 410 are pre-configured (e.g., trained on sample data) to determine tags. The static classifiers may include an ML-based classifier 412 (e.g., the ML classifier 210) and a regular expression (regex) based classifier 414 (e.g., the pattern recognition algorithm 214). Static classifiers 410 can be trained or configured (e.g., programmed) based on sample data 420 and corresponding metadata (e.g., manually assigned tags). The tags used to label the sample data 420 may be selected from a predefined taxonomy 440.

When the computer system 110 receives data from an external source, the computer system 110 may classify the data prior to storing the data in the datastore 122. Metadata 430 associated the data being classified can be input to the static classifier(s) 410 to determine a set of tags for the data. The metadata 430 may include column and table metadata (e.g., column information). The metadata 430 may further include the lineage of the data being classified and any existing tags that may be associated with the data based on lineage. For example, the data being classified may correspond to a child object, in which case one or more tags of a parent object may be automatically assigned to the data. Further, as discussed below, the tags available for assignment to data may be arranged in accordance with a hierarchically taxonomy in which tags share parent-child relationships.

Based on the metadata 430, the static classifiers may select one or more tags from the taxonomy 440 to form an initial set of tags 403 for input to the generative AI model 400 along with the metadata 430. The generative AI model may refine the tags 403 determined by the static classifiers 410 to output a final set of tags 405. The final set of tags 405 may include one or more additional tags that are not part of the initial tags 403. This two-stage classification process may provide for more comprehensive and accurate tag determination compared to using static classifiers alone. In this manner, tags that apply to incoming data can be automatically discovered and assigned, thereby reducing the amount of manual tagging performed. This is beneficial as manual tagging can be labor intensive and prone to human error. In some instances, one or more tags from the final set of tags 405 may be output as suggestions for manual review and assignment. For example, the classification system 116 may compute a confidence score for each tag that is output. When the confidence score for a tag is below a certain threshold, the classification system 116 can tentatively assign the tag and flag the assignment for manual review.

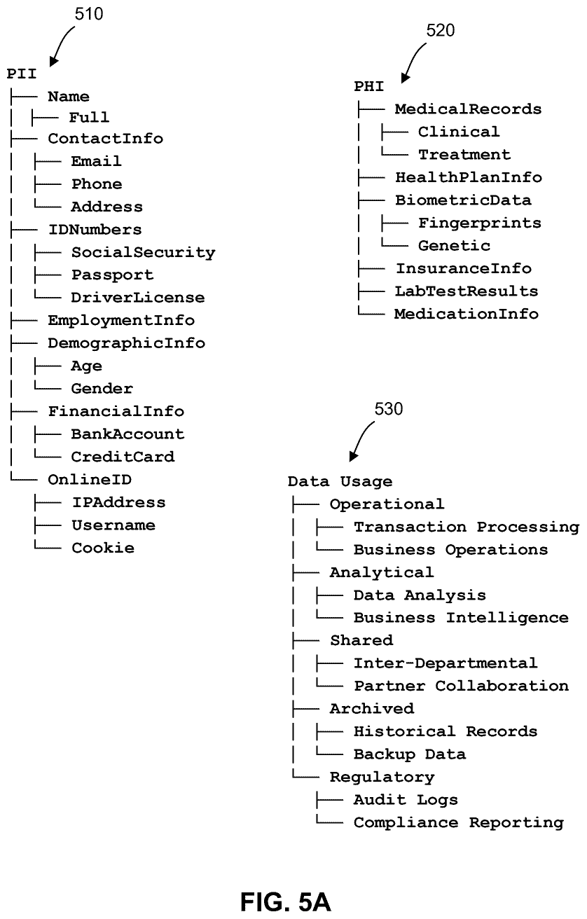

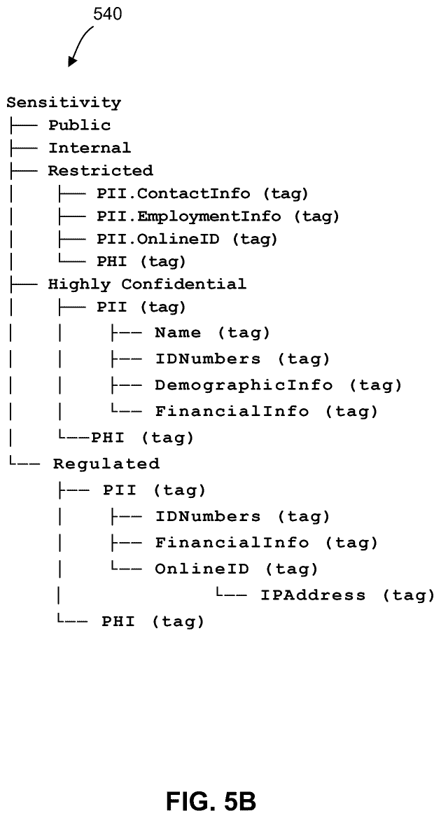

FIG. 5A shows examples of tag hierarchies, which can be modeled as tree structures. For example, in a first tag tree 510, a tag labeled “PII” may be linked to other tags related to personal information, such as tags indicating that data contains a name, an email address, a phone number, a passport number, a person's age, gender, and/or the like. In a second tag tree 520, a tag labeled “PHI” (protected health information) may be linked to tags indicating that data contains medical records, health plan information, biometric data, lab test results, medication information, and/or the like. Another example is tags related to data usage. In a third tag tree 530, a tag labeled “Data Usage” may be linked to tags indicating that data is operational (e.g., transaction processing data), analytical (e.g., results of data analysis), shared data (e.g., data shared between two owners), archival data, regulatory data, and/or the like.

In a tag hierarchy, a data resource that has been tagged with a child tag can be expected to also be tagged with the parent tag of the child tag. In this context, a “parent” tag can be any higher level tag (e.g., closer to the root of a tag tree) that is linked to the subject tag, whether directly or through another tag. Thus, the parent tag should exist if the data object has been assigned the child tag. Similarly, when data resources are arranged hierarchically, a child resource can be expected to inherit the tags of its parent resource. In this manner, tags may propagate according to resource lineage and/or tag lineage. In some implementations, each tag or tag association record may have a setting that allows for propagation to be disabled.

FIG. 5B shows an example of tag classifications. Like the tag hierarchies depicted in FIG. 5A, tag classifications can be modeled as trees (e.g., a fourth tag tree 540). However, tag classes are not necessarily assigned to data resources but may instead correspond to logical groupings of tags. For example, in the fourth tag tree 540, tags belonging to a “Restricted” class include tags associated with various types of PII (e.g., a “ContactInfo” tag, an “EmploymentInfo” tag, and an “OnlineID” tag). Further, the PII tag belongs to a “Highly Confidential” class and a “Regulated” class, since personally identifiable information may be considered both highly confidential and regulated irrespective of the type of personal information. Thus, an individual tag may be belong to more than one tag class.

Tag classification can serve as a convenient mechanism for enabling a policy to apply to new tags without requiring a policy author (e.g., admin 104) to update the policy. A policy may be created which references a tag class in order to capture all tags which currently belong to that class as well future tags that may be added to the same class. In this way, the policy author need not enumerate every tag to which the policy applies or will apply. Policies can be created which are generically applicable across datasets, including new data types that did not exist at the time a policy was authored. This allows policies to potentially remain valid throughout the lifecycle of the stored data even when changes in data structure occur (e.g., a change in the definition of a DLO or DMO). Thus, the frequency with which policies are updated may be significantly lower compared to governance methods that do not employ hierarchical tags. If a data owner decides to modify a policy (e.g., to accommodate a new regulation or for business reasons), new policy rules or changes to existing policy rules can easily be implemented through configuring the policy evaluation logic (e.g., conditional statements in programming language) to operate using tags as input parameters.

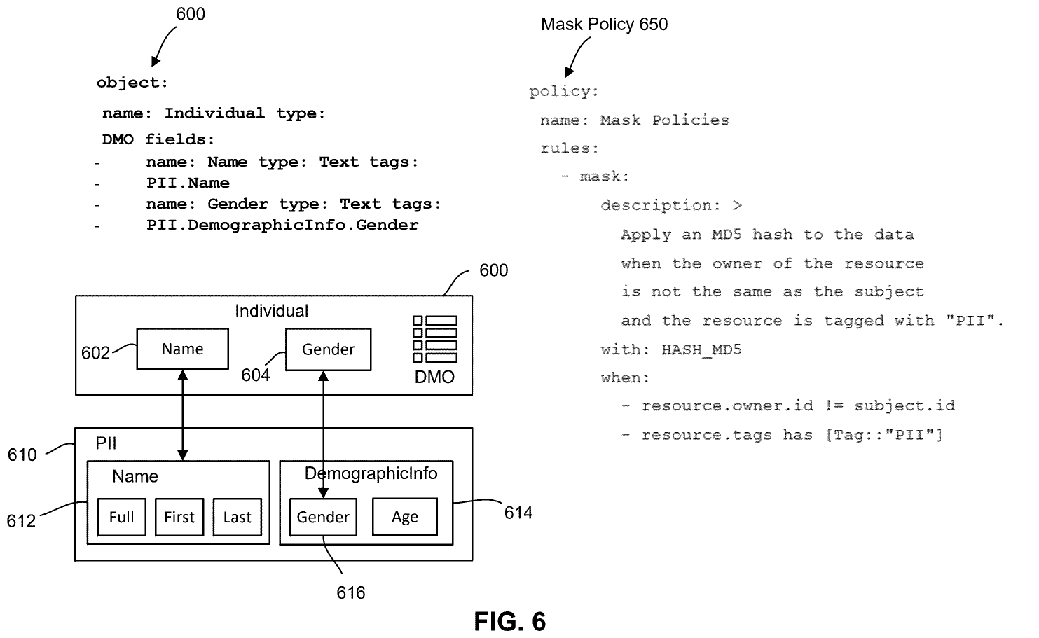

FIG. 6 shows an example of a data object and a mask policy 650 applicable to the data object, according to certain implementations. In this example, the data object is a DMO 600 named “Individual” and includes fields for a person's name and gender. Each field may correspond to a separate column of the DMO 600 when the DMO is displayed in table form. FIG. 6 includes a visual representation of DMO 600 and a definition file corresponding to a computer-encoded representation of the DMO 600. As shown in FIG. 6, the DMO 600 includes a name field 602 and a gender field 604. The name field 602 is associated with a tag 610 labeled “PII” and a tag 612 labeled “Name”. The gender field is associated with the PII tag 610, a tag 614 labeled “DemographicInfo”, and a tag 616 labeled “Gender”. FIG. 6 also shows the hierarchical relationship between these tags. In particular, the Name tag 612 and the DemographicInfo tag 614 are subsumed within the scope of the PII tag 610, and the Gender tag 616 is subsumed within the scope of the DemographicInfo tag 614.

Mask policy 650 is configured to provide for masking of data when the data is tagged as PII (e.g., assigned the tag 610) and the owner of the data resource is not the user requesting access (the “subject” in ABAC terminology). In this example, the mask policy 650 specifies a hash algorithm as the transformation function for masking data. However, masking can be performed in other ways, such as setting the data to null or empty.

FIG. 6 shows the mask policy 650 as a definition file having conditional statements, but the evaluation logic can equivalently be expressed in natural language as “mask all PII columns to non-object-owners.” Therefore, the mask policy 650 and other policies employed by an ABAC system could potentially be authored using natural language processing and/or generative AI. For example, the computer system 110 may generate the mask policy 650 by applying a natural language understanding (NLU) algorithm to a text statement supplied by the admin 104. Alternatively, the computer system 110 may generate the mask policy 650 by using the text statement as an input prompt to a large language model (LLM).

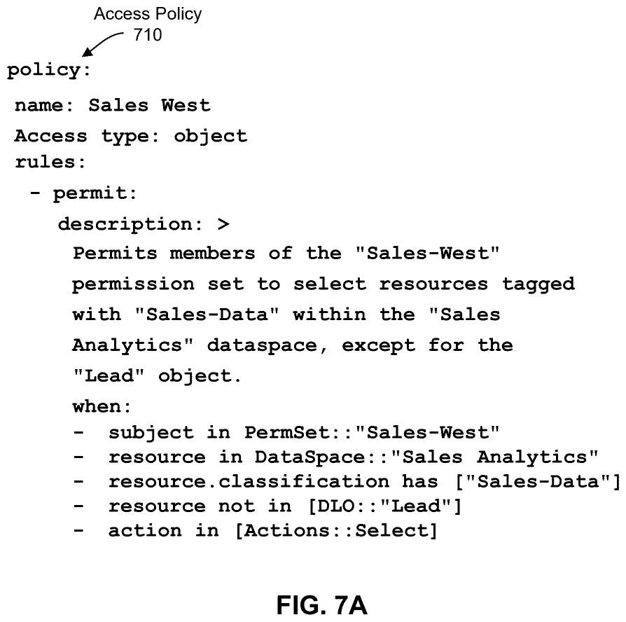

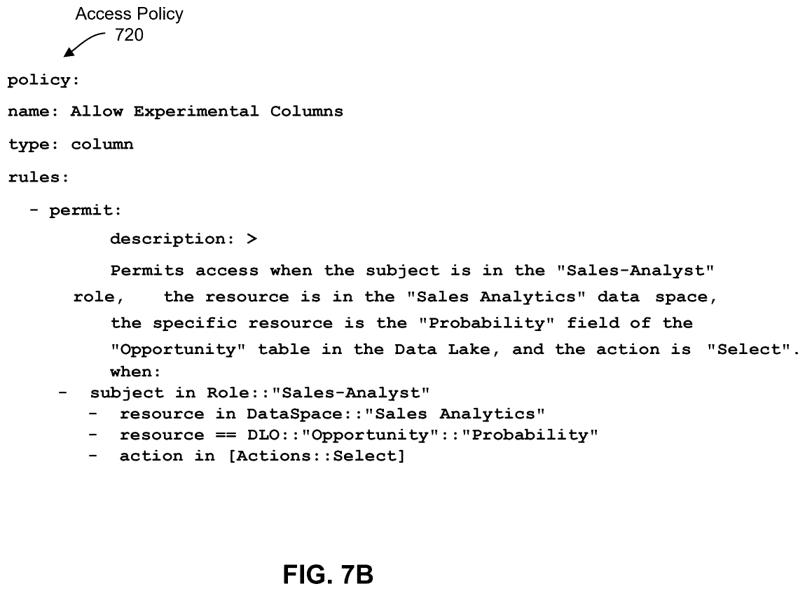

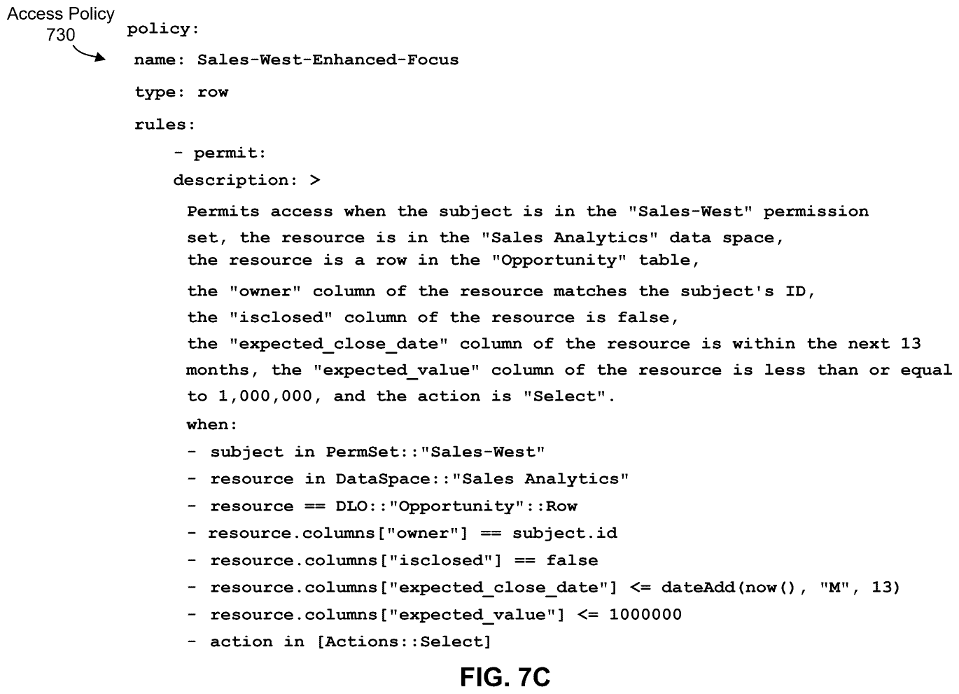

FIG. 7A shows an example of an access policy 710 that permits users who are members of the “Sales-West” group to perform a select action on any resource in the “Sales Analytics” data space which has been assigned the “Sales-Data” tag, except for a data object named “Lead”.

FIG. 7B shows an example of an access policy 720 that permits users who have been assigned the role “Sales-Analyst” to select a resource in the “Sales Analytics” data space when the resource corresponds to the “Probability” field/column of a table named “Opportunity”.

FIG. 7C shows an example of an access policy 730 that permits a user who is a member of “Sales-West” to select a resource in the “Sales Analytics” data space when the resource is a row of the “Opportunity” table, the user requesting access matches the user ID in the “owner” column of the resource, the “isclosed” column of the resource is false, the “expected_close_date” column of the resource is within the next 13 months, and the “expected_value”column of the resource is less than or equal to 1,000,000.

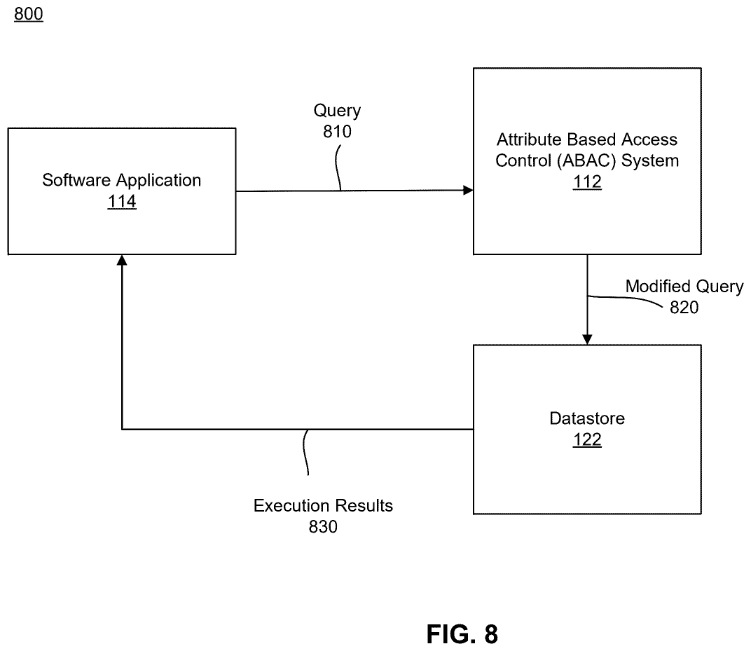

FIG. 8 illustrates a process 800 for handling an access request, according to certain implementations. The process 800 may begin with the software application 114 sending a query 810 to the ABAC system 112. The query 810 corresponds to an access request from a user (e.g., the request 101) and may include or identify an instruction to be executed by a compute engine configured to provide access to data. For instance, the compute engine may include one or more processors associated with the datastore 122. In some implementations, the query 810 may be formatted as a SQL query that includes one or more SQL statements for performing an action with respect to a particular data resource. For instance, the query 810 may include a SQL SELECT statement indicating which fields of a table are to be retrieved for output to the user. As another example, the query 810 may include a SQL UPDATE statement configured to update a table (e.g., by writing to one or more columns in a particular row of a DLO/DMO).

ABAC system 112 may receive the query 810 and evaluate one or more policies that apply to the query 810 (e.g., policies with rules referring to tags that have been assigned to the data being accessed). Based on the results of the policy evaluation, the ABAC system 112 may generate a modified query 820 by rewriting the query 810 so that one or more actions are performed differently. For example, the modified query 820 may include a modified SQL SELECT statement reflecting the omission of a particular field because a policy has disallowed access to that field by the user. The modified query 820 may be input to the compute engine for execution with respect to the contents of the datastore 122. Execution results 830 may be returned to the software application 114 for communication to the user. In the case of an action involving a read operation (e.g., select), the execution results 830 may include filtered data corresponding to only those parts of the originally requested data the user is permitted to access.

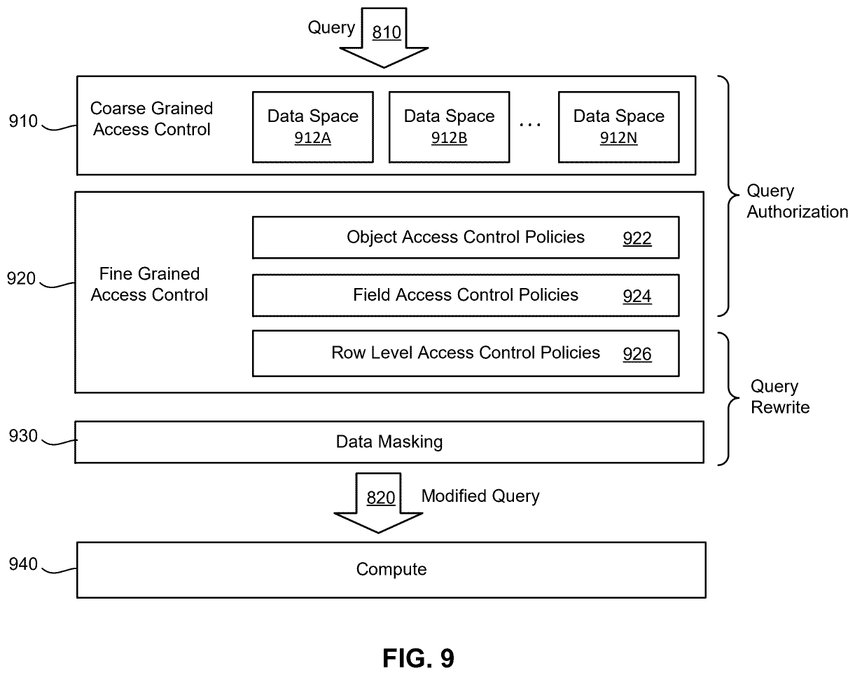

FIG. 9 shows an example of governance policies applied at different levels of a data stack, according to certain implementations. The data stack may correspond to the datastore 122 and can be implemented using software, hardware, or a combination of software and hardware, to collect, process, and store data. In the example of FIG. 9, the query 810 is the subject of various access control decisions directed to stored data at different levels. At least some of these access control decisions are based on policy evaluation. For example, the ABAC system 112 can make an authorization decision for the query 810 based on user, environment, and data resource attributes to determine whether the user is allowed to access a particular data space (e.g., one of data spaces 912A-921N), a particular data object within that data space, a particular row within that data object, and/or a particular field within that row. Thus, the authorization decision may involve one or more data-space-level access control policies (not shown), one or more object-level access control policies 922, one or more field-level access control policies 924, and/or one or more row-level access control policies 926. The authorization decision may also involve one or more “allow” policies and/or one or more “disallow” policies. For example, the authorization decision can be based on evaluating a first policy and a second policy, where the first policy specifies conditions under which access is allowed, and the second policy specifies conditions under which access is denied.

Accordingly, the processing of the query 810 may be divided into a coarse-grained access control stage 910 and a fine-grained access control stage 920, followed by data masking stage 930 and a compute stage 940. The data masking stage 930 may generate the modified query 820 for input to the compute stage 940. The data masking stage 930 can be skipped if the results of the policy evaluation during the access control stages 910 and 920 indicate that there is no data for which access is authorized. As discussed above, the modified query 820 can be generated through rewriting the initial query 810 based on the results of policy evaluation. Query authorization and rewriting can be divided across different stages. In the example of FIG. 9, query authorization corresponds to the coarse-grained access control stage 910 and a beginning of the fine-grained access control stage 920. The beginning of the fine-grained access control stage 920 involves evaluation of object-level access control policies 922 and field-level access control policies 924. Evaluation of row-level access control policies 926 may be performed as part of query rewriting. For example, one or more row-level access control policies 926 may provide for row-level filtering. Separate from the row-level filtering, the data masking stage 930 may involve masking of individual fields (e.g., columns) through evaluation of one or more masking policies (e.g., the mask policy 650 in FIG. 6). Thus, query rewriting may be implemented using a combination of row-level access control policies and field-level masking policies.

In some implementations, the access control system processing the query 810 (e.g., ABAC system 112) may supplement the modified query 820 by performing post-filtering and/or data masking on data returned from the compute engine (e.g., the execution results 830). As with modifying the initial query 810, the post-filtering or data masking can be based on policy evaluation. For example, the evaluation of one or more row-level access control policies 926 may be deferred to the post-filtering stage.

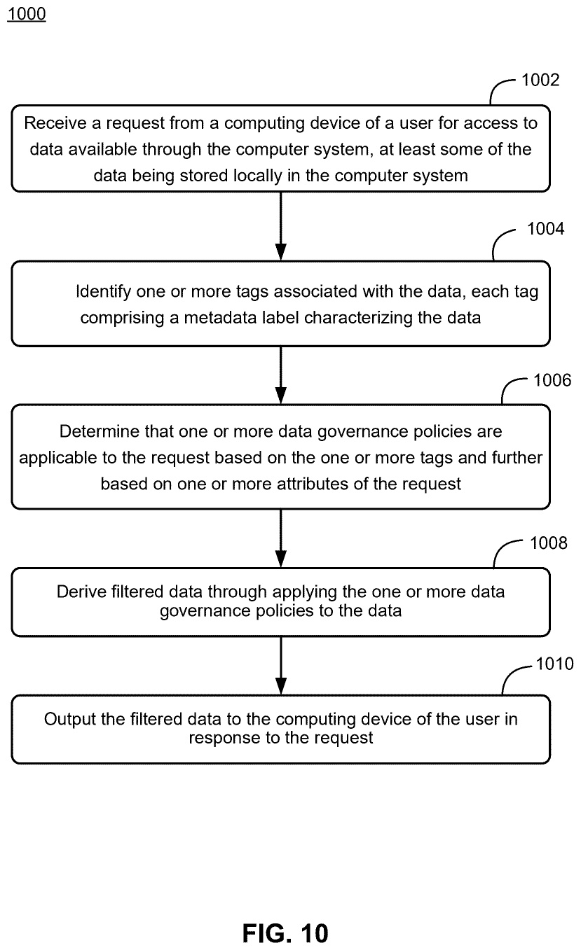

FIG. 10 is a flow diagram of an example method 1000 for providing access control over data, according to certain implementations. The method 1000 can be performed by one or more processors of computer system having an access control component (e.g., ABAC system 112).

At block 1002, the computer system receives a request from a computing device of a user (e.g., user computer system 120B) for access to data available through the computer system. At least some of the data requested is stored locally in the computer system (e.g., in datastore 122).

At block 1004, the computer system identifies one or more tags associated with the data. Each tag includes a metadata label characterizing the data (e.g., a label describing an attribute of a data resource).

At block 1006, the computer system determines that one or more data governance policies are applicable to the request. The determination in block 1006 is based on the one or more tags identified in block 1004. The determination in block 1006 is further based on one or more attributes of the request (e.g., an action requested to be performed on the data). In some instances, an attribute of the request may be an attribute associated with the user (e.g., username/ID or user role) or an attribute associated with the computing environment. Examples of such attributes were discussed above in connection with FIG. 3. Attributes of the request can be determined from the request itself (e.g., a header of a message conveying the request) and/or from contextual information about the request. For example, the computer system may timestamp the request with a time of receipt. Further, the computer system may be aware of the geographic location from which the request originates (e.g., an Internet Protocol (IP) address of the user's computing device). The computer system may also infer the purpose of the request based on a channel through which the request is received. For example, the request may be directed to a particular component (e.g., a program module) of a CRM application that includes a marketing component, a sales or e-commerce component, a data analytics component, a customer service component, and a finance or accounting component. The computer system may determine that the requested data will be used in different ways depending on which component the request is directed to.

At block 1008, the computer system derives filtered data through applying the one or more data governance policies determined in block 1006 to the data. For example, as discussed above in reference to FIGS. 8 and 9, a modified query may be generated for obtaining data that has been filtered and/or masked.

At block 1010, the filtered data can be output to the computing device of the user in response to the request. For example, the filtered data may be presented as a table on a display screen of the computing device.

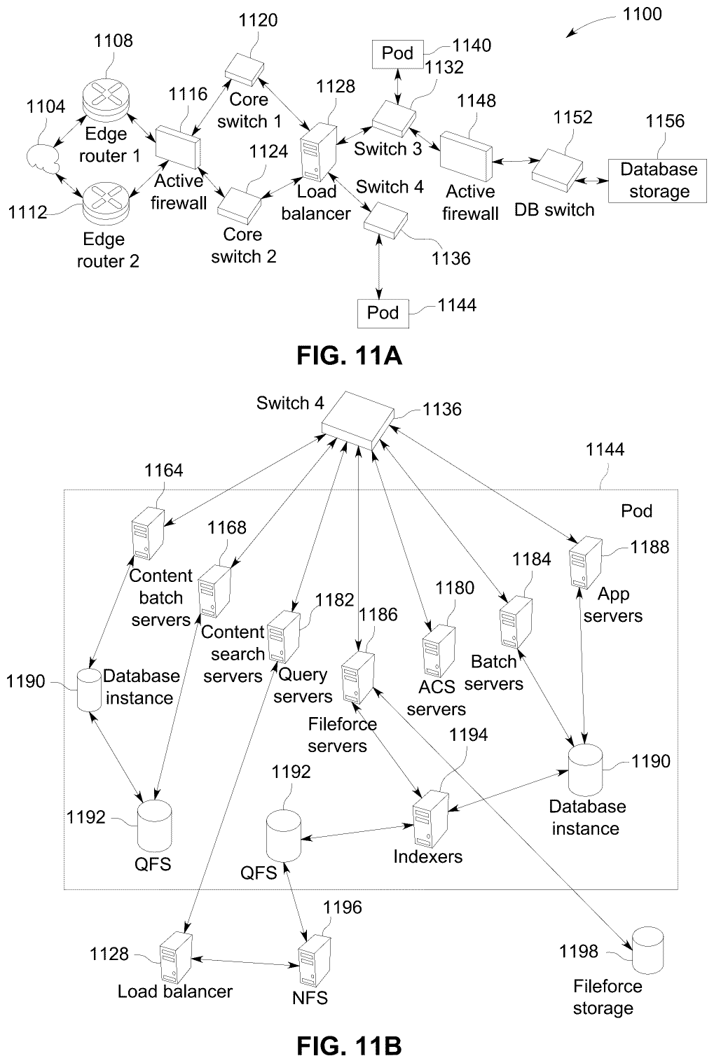

FIG. 11A shows a system diagram illustrating architectural components of an on-demand service environment 1100 in which implementations enabled by the present disclosure may be practiced. For instance, the on-demand service environment 1100 may correspond to an implementation of computing environment 100 in FIG. 1. A client machine located in the cloud 1104 (or Internet) may communicate with the on-demand service environment via one or more edge routers 1108 and 1112. The edge routers may communicate with one or more core switches 1120 and 1124 via firewall 1116. The core switches may communicate with a load balancer 1128, which may distribute server load over different pods, such as pods 1140 and 1144. The pods 1140 and 1144, which may each include one or more servers and/or other computing resources, may perform data processing and other operations used to provide on-demand services. Communication with the pods may be conducted via pod switches 1132 and 1136. Components of the on-demand service environment may communicate with a database storage system 1156 via a database firewall 1148 and a database switch 1152.

As shown in FIGS. 11A and 11B, accessing an on-demand service environment may involve communications transmitted among a variety of different hardware and/or software components. Further, the on-demand service environment 1100 is a simplified representation of an actual on-demand service environment. For example, while only one or two devices of each type are shown in FIGS. 11A and 11B, some implementations of an on-demand service environment may include anywhere from one to many devices of each type. Also, the on-demand service environment need not include each device shown in FIGS. 11A and 11B or may include additional devices not shown in FIGS. 11A and 11B.

Moreover, one or more of the devices in the on-demand service environment 1100 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 1104 is intended to refer to a data network or plurality of data networks, often including the Internet. Client machines located in the cloud 1104 may communicate with the on-demand service environment to access services provided by the on-demand service environment. For example, client machines may access the on-demand service environment to retrieve, store, edit, and/or process information.

In some implementations, the edge routers 1108 and 1112 route packets between the cloud 1104 and other components of the on-demand service environment 1100. The edge routers 1108 and 1112 may employ the Border Gateway Protocol (BGP). The BGP is the core routing protocol of the Internet. The edge routers 1108 and 1112 may maintain a table of IP networks or ‘prefixes’ which designate network reachability among autonomous systems on the Internet.

In one or more implementations, the firewall 1116 may protect the inner components of the on-demand service environment 1100 from Internet traffic. The firewall 1116 may block, permit, or deny access to the inner components of the on-demand service environment 1100 based upon a set of rules and other criteria. The firewall 1116 may act as one or more of a packet filter, an application gateway, a stateful filter, a proxy server, or any other type of firewall.

In some implementations, the core switches 1120 and 1124 are high-capacity switches that transfer packets within the on-demand service environment 1100. The core switches 1120 and 1124 may be configured as network bridges that quickly route data between different components within the on-demand service environment. In some implementations, the use of two or more core switches 1120 and 1124 may provide redundancy and/or reduced latency.

In some implementations, the pods 1140 and 1144 may perform the core data processing and service functions provided by the on-demand service environment. Each pod may include various types of hardware and/or software computing resources. An example of the pod architecture is discussed in greater detail with reference to FIG. 11B.

In some implementations, communication between the pods 1140 and 1144 may be conducted via the pod switches 1132 and 1136. The pod switches 1132 and 1136 may facilitate communication between the pods 1140 and 1144 and client machines located in the cloud 1104, for example via core switches 1120 and 1124. Also, the pod switches 1132 and 1136 may facilitate communication between the pods 1140 and 1144 and the database storage 1156.

In some implementations, the load balancer 1128 may distribute workload between the pods 1140 and 1144. Balancing the on-demand service requests between the pods may assist in improving the use of resources, increasing throughput, reducing response times, and/or reducing overhead. The load balancer 1128 may include multilayer switches to analyze and forward traffic.

In some implementations, access to the database storage 1156 may be guarded by a database firewall 1148. The database firewall 1148 may act as a computer application firewall operating at the database application layer of a protocol stack. The database firewall 1148 may protect the database storage 1156 from application attacks such as structured query language (SQL) injection, database rootkits, and unauthorized information disclosure.

In some implementations, the database firewall 1148 may include a host using one or more forms of reverse proxy services to proxy traffic before passing it to a gateway router. The database firewall 1148 may inspect the contents of database traffic and block certain content or database requests. The database firewall 1148 may work on the SQL application level atop the TCP/IP stack, managing applications'connection to the database or SQL management interfaces as well as intercepting and enforcing packets traveling to or from a database network or application interface.

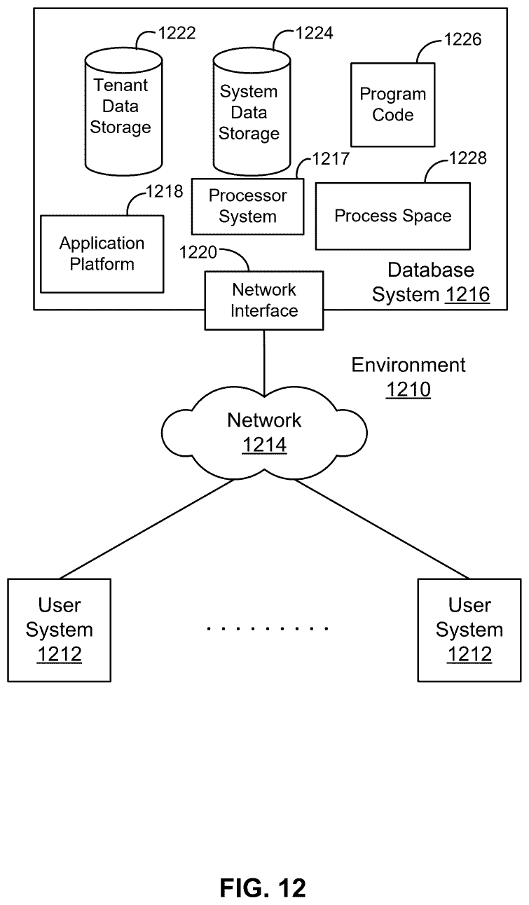

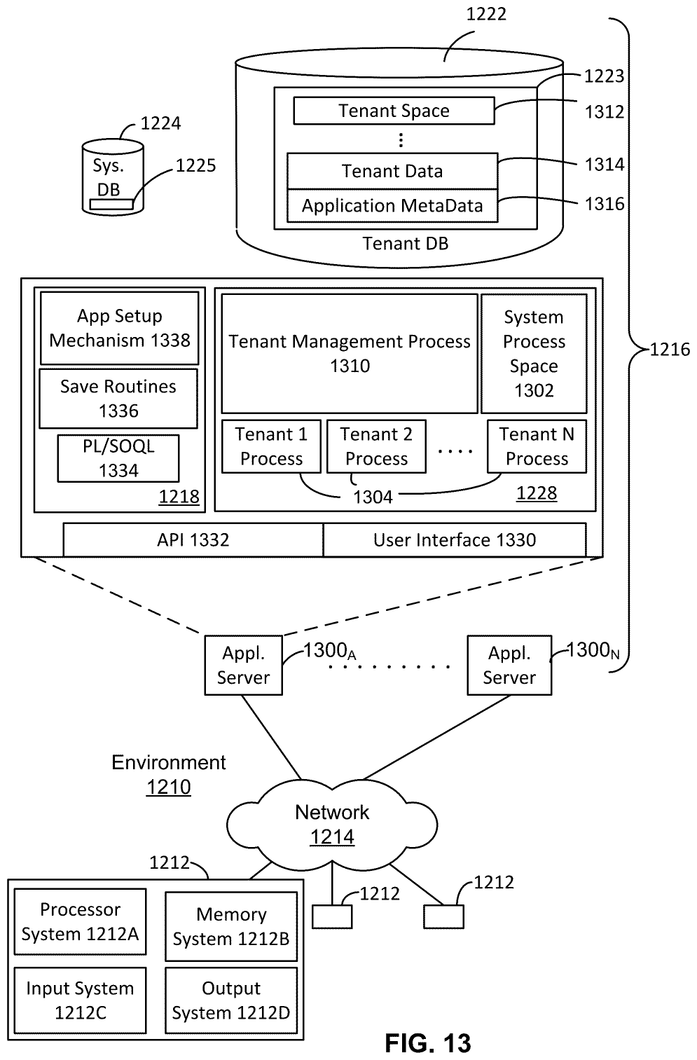

In some implementations, communication with the database storage system 1156 may be conducted via the database switch 1152. The multi-tenant database system 1156 may include more than one hardware and/or software components for handling database queries. Accordingly, the database switch 1152 may direct database queries transmitted by other components of the on-demand service environment (e.g., the pods 1140 and 1144) to the correct components within the database storage system 1156. In some implementations, the database storage system 1156 is an on-demand database system shared by many different organizations. The on-demand database system may employ a multi-tenant approach, a virtualized approach, or any other type of database approach. An on-demand database system is discussed in greater detail with reference to FIGS. 12 and 13.

FIG. 11B shows a system diagram illustrating the architecture of the pod 1144, according to certain implementations. The pod 1144 may be used to render services to a user of the on-demand service environment 1100. In some implementations, each pod may include a variety of servers and/or other systems. The pod 1144 includes one or more content batch servers 1164, content search servers 1168, query servers 1182, Fileforce servers 1186, access control system (ACS) servers 1180, batch servers 1184, and app servers 1188. Also, the pod 1144 includes database instances 1190, quick file systems (QFS) 1192, and indexers 1194. In one or more implementations, some or all communication between the servers in the pod 1144 may be transmitted via the switch 1136.

In some implementations, the application servers 1188 may include a hardware and/or software framework dedicated to the execution of procedures (e.g., programs, routines, scripts) for supporting the construction of applications provided by the on-demand service environment 1100 via the pod 1144. Some such procedures may include operations for providing the services described herein. The content batch servers 1164 may handle requests internal to the pod. These requests may be long-running and/or not tied to a particular customer. For example, the content batch servers 1164 may handle requests related to log mining, cleanup work, and maintenance tasks.

The content search servers 1168 may provide query and indexer functions. For example, the functions provided by the content search servers 1168 may allow users to search through content stored in the on-demand service environment. The Fileforce servers 1186 may manage requests for information stored in the Fileforce storage 1198. The Fileforce storage 1198 may store information such as documents, images, and basic large objects (BLOBs). By managing requests for information using the Fileforce servers 1186, the image footprint on the database may be reduced.

The query servers 1182 may be used to retrieve information from one or more file systems. For example, the query servers 1182 may receive requests for information from the app servers 1188 and then transmit information queries to network file systems (NFS) 1196 located outside the pod. The pod 1144 may share a database instance 1190 configured as a multi-tenant environment in which different organizations share access to the same database. Additionally, services rendered by the pod 1144 may require various hardware and/or software resources. In some implementations, the ACS servers 1180 may control access to data, hardware resources, or software resources.

In some implementations, the batch servers 1184 may process batch jobs, which are used to run tasks at specified times. Thus, the batch servers 1184 may transmit instructions to other servers, such as the app servers 1188, to trigger the batch jobs. For some implementations, the QFS 1192 may be an open source file system. The QFS may serve as a rapid-access file system for storing and accessing information available within the pod 1144. The QFS 1192 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 1168 and/or indexers 1194 to identify, retrieve, move, and/or update data stored in the NFS 1196 and/or other storage systems.

In some implementations, one or more query servers 1182 may communicate with the NFS 1196 to retrieve and/or update information stored outside of the pod 1144. The NFS 1196 may allow servers located in the pod 1144 to access information to access files over a network in a manner similar to how local storage is accessed. In some implementations, queries from the query servers 1182 may be transmitted to the NFS 1196 via the load balancer 1128, which may distribute resource requests over various resources available in the on-demand service environment. The NFS 1196 may also communicate with the QFS 1192 to update the information stored on the NFS 1196 and/or to provide information to the QFS 1192 for use by servers located within the pod 1144.

In some implementations, the pod may include one or more database instances 1190. The database instance 1190 may transmit information to the QFS 1192. When information is transmitted to the QFS, it may be available for use by servers within the pod 1144 without requiring an additional database call. In some implementations, database information may be transmitted to the indexer 1194. Indexer 1194 may provide an index of information available in the database 1190 and/or QFS 1192. The index information may be provided to Fileforce servers 1186 and/or the QFS 1192.

FIG. 12 shows a block diagram of an environment 1210 wherein an on-demand database service might be used, in accordance with some implementations. Environment 1210 includes an on-demand database service 1216. User system 1212 may be any machine or system that is used by a user to access a database system and may be embodied as a standalone device or multiple devices. For example, any of user systems 1212 can be a handheld computing system, a mobile phone, a laptop computer, a workstation, and/or a network of computing systems. As illustrated in FIGS. 12 and 13, user systems 1212 might interact via a network 1214 with the on-demand database service 1216.

An on-demand database service, such as system 1216, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 1216” and “system 1216” will be used interchangeably herein. A database image may include one or more database objects. A relational database management system (RDBMS) or the equivalent may execute storage and retrieval of information against the database object(s). Application platform 1218 may be a framework that allows the applications of system 1216 to run, such as the hardware and/or software, e.g., the operating system. In an implementation, on-demand database service 1216 may include an application platform 1218 that enables creation, managing and executing one or more applications developed by the provider of the on-demand database service, users accessing the on-demand database service via user systems 1212, or third party application developers accessing the on-demand database service via user systems 1212.

One arrangement for elements of system 1216 is shown in FIG. 12, including a network interface 1220, application platform 1218, tenant data storage 1222 for tenant data (e.g., tenant data 1223 in FIG. 13), system data storage 1224 for system data 1225 accessible to system 1216 and possibly multiple tenants, program code 1226 for implementing various functions of system 1216, and a process space 1228 for executing MTS system processes and tenant-specific processes, such as running applications as part of an application hosting service. Additional processes that may execute on system 1216 include database indexing processes.

The users of user systems 1212 may differ in their respective capacities, and the capacity of a particular user system 1212 might be entirely determined by permissions (permission levels) for the current user. For example, where a call center agent is using a particular user system 1212 to interact with system 1216, the user system 1212 has the capacities allotted to that call center agent. However, while an administrator is using that user system to interact with system 1216, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level.

Network 1214 is any network or combination of networks of devices that communicate with one another. For example, network 1214 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network (e.g., the Internet), that network will be used in many of the examples herein. However, it should be understood that the networks used in some implementations are not so limited, although TCP/IP is a frequently implemented protocol.

User systems 1212 might communicate with system 1216 using TCP/IP and, at a higher network level, use other common Internet protocols to communicate, such as HTTP, FTP, AFS, WAP, etc. In an example where HTTP is used, user system 1212 might include an HTTP client commonly referred to as a “browser” for sending and receiving HTTP messages to and from an HTTP server at system 1216. Such an HTTP server might be implemented as the sole network interface between system 1216 and network 1214, but other techniques might be used as well or instead. In some implementations, the interface between system 1216 and network 1214 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In some implementations, system 1216, shown in FIG. 12, implements a web-based customer relationship management (CRM) system. For example, in some implementations, system 1216 includes application servers configured to implement and execute CRM software applications as well as provide related data, code, forms, webpages and other information to and from user systems 1212 and to store to, and retrieve from, a database system related data, objects, and webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain implementations, system 1216 implements applications other than, or in addition to, a CRM application. For example, system 1216 may provide tenant access to multiple hosted (standard and custom) applications. User (or third party developer) applications, which may or may not include CRM, may be supported by the application platform 1218, which manages creation, storage of the applications into one or more database objects and executing of the applications in a virtual machine in the process space of the system 1216.

Each user system 1212 could include a desktop personal computer, workstation, laptop, PDA, cell phone, or any wireless access protocol (WAP) enabled device or any other computing system capable of interfacing directly or indirectly to the Internet or other network connection. User system 1212 typically runs an HTTP client, e.g., a browsing program, such as Microsoft's Internet Explorer® browser, Mozilla's Firefox® browser, Opera's browser, or a WAP-enabled browser in the case of a cell phone, PDA or other wireless device, or the like, allowing a user (e.g., subscriber of the multi-tenant database system) of user system 1212 to access, process and view information, pages and applications available to it from system 1216 over network 1214.

Each user system 1212 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 1216 or other systems or servers. For example, the user interface device can be used to access data and applications hosted by system 1216, and to perform searches on stored data, and otherwise allow a user to interact with various GUI pages that may be presented to a user. As discussed above, implementations are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to some implementations, each user system 1212 and all of its components are operator configurable using applications, such as a browser, including computer code run using a central processing unit such as an Intel Pentium® processor or the like. Similarly, system 1216 (and additional instances of an MTS, where more than one is present) and all of their components might be operator configurable using application(s) including computer code to run using a central processing unit such as processor system 1217, which may include an Intel Pentium® processor or the like, and/or multiple processor units.

A computer program product implementation includes a machine-readable storage medium (media) having instructions stored thereon/in which can be used to program a computer to perform any of the processes of the implementations described herein.

Computer code for operating and configuring system 1216 to intercommunicate and to process webpages, applications and other data and media content as described herein are preferably downloaded and stored on a hard disk, but the entire program code, or portions thereof, may also be stored in any other volatile or non-volatile memory medium or device, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, or transmitted over any other conventional network connection (e.g., extranet, VPN, LAN, etc.) using any communication medium and protocols (e.g., TCP/IP, HTTP, HTTPS, Ethernet, etc.). It will also be appreciated that computer code for carrying out disclosed operations can be implemented in any programming language that can be executed on a client system and/or server or server system such as, for example, C, C++, HTML, any other markup language, Java®, JavaScript®, ActiveX®, any other scripting language, such as VBScript, and many other programming languages as are well known may be used. (Java®, JavaScript®, and Oracle® are registered trademarks of Oracle Corp. and/or its affiliates).

According to some implementations, each system 1216 is configured to provide webpages, forms, applications, data and media content to user (client) systems 1212 to support the access by user systems 1212 as tenants of system 1216. As such, system 1216 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include logically and/or physically connected servers distributed locally or across one or more geographic locations. Additionally, the term “server” is meant to include a computing system, including processing hardware and process space(s), and an associated storage system and database application (e.g., OODBMS or RDBMS) as is well known in the art.

It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 13 shows a block diagram of environment 1210 further illustrating system 1216 and various interconnections, in accordance with some implementations. FIG. 13 shows that user system 1212 may include processor system 1212A, memory system 1212B, input system 1212C, and output system 1212D. FIG. 12 shows network 1214 and system 1216. FIG. 13 also shows that system 1216 may include tenant data storage 1222, tenant data 1223, system data storage 1224, system data 1225, User Interface (UI) 1330, Application Programming Interface (API) 1332, PL/SOQL code 1334, save routines 1336, application setup mechanism 1338, applications servers 1300A-1300N, system process space 1302, tenant process spaces 1304, tenant management process space 1310, tenant storage area 1312, user storage 1314, and application metadata 1316. In other implementations, environment 1210 may not have the same elements as those listed above and/or may have other elements instead of, or in addition to, those listed above.

User system 1212, network 1214, system 1216, tenant data storage 1222, and system data storage 1224 were discussed above in FIG. 12. Regarding user system 1212, processor system 1212A may be any combination of processors. Memory system 1212B may be any combination of one or more memory devices, short term, and/or long term memory. Input system 1212C may be any combination of input devices, such as keyboards, mice, trackballs, scanners, cameras, and/or interfaces to networks. Output system 1212D may be any combination of output devices, such as monitors, printers, and/or interfaces to networks. As shown by FIG. 13, system 1216 may include a network interface 1220 (of FIG. 12) implemented as a set of HTTP application servers 1300, an application platform 1218, tenant data storage 1222, and system data storage 1224. Also shown is system process space 1302, including individual tenant process spaces 1304 and a tenant management process space 1310. Each application server 1300 may be configured to tenant data storage 1222 and the tenant data 1223 therein, and system data storage 1224 and the system data 1225 therein to serve requests of user systems 1212. The tenant data 1223 might be divided into individual tenant storage areas 1312, which can be either a physical arrangement and/or a logical arrangement of data. Within each tenant storage area 1312, user storage 1314 and application metadata 1316 might be similarly allocated for each user. For example, a copy of a user's most recently used (MRU) items might be stored to user storage 1314. Similarly, a copy of MRU items for an entire organization that is a tenant might be stored to tenant storage area 1312. A UI 1330 provides a user interface and an API 1332 provides an application programmer interface to system 1216 resident processes to users and/or developers at user systems 1212. The tenant data and the system data may be stored in various databases, such as Oracle® databases.

Application platform 1218 includes an application setup mechanism 1338 that supports application developers'creation and management of applications, which may be saved as metadata into tenant data storage 1222 by save routines 1336 for execution by subscribers as tenant process spaces 1304 managed by tenant management process 1310 for example. Invocations to such applications may be coded using PL/SOQL code 1334 that provides a programming language style interface extension to API 1332. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is hereby incorporated by reference in its entirety and for all purposes. Invocations to applications may be detected by system processes, which manage retrieving application metadata 1316 for the subscriber making the invocation and executing the metadata as an application in a virtual machine.

Each application server 1300 may be communicably coupled to database systems, e.g., having access to system data 1225 and tenant data 1223, via a different network connection. For example, one application server 1300 might be coupled via the network 1214 (e.g., the Internet), another application server 1300 might be coupled via a direct network link, and another application server 1300 might be coupled by yet a different network connection. Transfer Control Protocol and Internet Protocol (TCP/IP) are typical protocols for communicating between application servers 1300 and the database system. However, other transport protocols may be used to optimize the system depending on the network interconnect used.

In certain implementations, each application server 1300 is configured to handle requests for any user associated with any organization that is a tenant. Because it is desirable to be able to add and remove application servers from the server pool at any time for any reason, there is preferably no server affinity for a user and/or organization to a specific application server 1300. In some implementations, therefore, an interface system implementing a load balancing function (e.g., an F5 Big-IP load balancer) is communicably coupled between the application servers 1300 and the user systems 1212 to distribute requests to the application servers 1300. In some implementations, the load balancer uses a least connections algorithm to route user requests to the application servers 1300. Other examples of load balancing algorithms, such as round robin and observed response time, also can be used. For example, in certain implementations, three consecutive requests from the same user could hit three different application servers 1300, and three requests from different users could hit the same application server 1300. In this manner, system 1216 is multi-tenant, wherein system 1216 handles storage of, and access to, different objects, data and applications across disparate users and organizations.

As an example of storage, one tenant might be a company that employs a sales force where each call center agent uses system 1216 to manage their sales process. Thus, a user might maintain contact data, leads data, customer follow-up data, performance data, goals and progress data, etc., all applicable to that user's personal sales process (e.g., in tenant data storage 1222). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a call center agent is visiting a customer and the customer has Internet access in their lobby, the call center agent can obtain critical updates as to that customer while waiting for the customer to arrive in the lobby.

While each user's data might be separate from other users'data regardless of the employers of each user, some data might be organization-wide data shared or accessible by a plurality of users or all of the users for a given organization that is a tenant. Thus, there might be some data structures managed by system 1216 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 1216 might also maintain system level data usable by multiple tenants or other data. Such system level data might include industry reports, news, postings, and the like that are sharable among tenants.

In certain implementations, user systems 1212 (which may be client machines/systems) communicate with application servers 1300 to request and update system-level and tenant-level data from system 1216 that may require sending one or more queries to tenant data storage 1222 and/or system data storage 1224. System 1216 (e.g., an application server 1300 in system 1216) automatically generates one or more SQL statements (e.g., SQL queries) that are designed to access the desired information. System data storage 1224 may generate query plans to access the requested data from the database.

Each database can generally be viewed as a collection of objects, such as a set of logical tables, containing data fitted into predefined categories. A “table” is one representation of a data object and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for account, contact, lead, and opportunity data, each containing pre-defined fields. It should be understood that the word “entity” may also be used interchangeably herein with “object”and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, Titled Custom Entities and Fields in a Multi-tenant Database SYSTEM, by Weissman, et al., and which is hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. In some implementations, multiple “tables” for a single customer may actually be stored in one large table and/or in the same table as the data of other customers.

These and other aspects of the disclosure may be implemented by various types of hardware, software, firmware, etc. For example, some features of the disclosure may be implemented, at least in part, by machine-program product that include program instructions, state information, etc., for performing various operations described herein. Examples of program instructions include both machine code, such as produced by a compiler, and files containing higher-level code that may be executed by the computer using an interpreter. Examples of machine-program product include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

While one or more implementations and techniques are described with reference to an implementation in which a service cloud console is implemented in a system having an application server providing a front end for an on-demand database service capable of supporting multiple tenants, the one or more implementations and techniques are not limited to multi-tenant databases nor deployment on application servers. Implementations may be practiced using other database architectures, i.e., ORACLE®, Db2® by IBM and the like without departing from the scope of the implementations claimed.

Any of the above implementations may be used alone or together with one another in any combination. Although various implementations may have been motivated by various deficiencies with the prior art, which may be discussed or alluded to in one or more places in the specification, the implementations do not necessarily address any of these deficiencies. In other words, different implementations may address different deficiencies that may be discussed in the specification. Some implementations may only partially address some deficiencies or just one deficiency that may be discussed in the specification, and some implementations may not address any of these deficiencies.

While various implementations have been described herein, it should be understood that they have been presented by way of example only, and not limitation. Thus, the breadth and scope of the present application should not be limited by any of the implementations described herein but should be defined only in accordance with the following and later-submitted claims and their equivalents.

What is claimed is:

1. A computer-implemented method comprising:
receiving a request from a computing device of a user for access to data available through a computer system, at least some of the data being stored locally in the computer system;
identifying one or more tags associated with the data, each tag comprising a metadata label characterizing the data;
determining that one or more data governance policies are applicable to the request based on the one or more tags and further based on one or more attributes of the request;
deriving filtered data through applying the one or more data governance policies to the data; and
outputting the filtered data to the computing device of the user in response to the request.

2. The method of claim 1, wherein determining that one or more data governance policies are applicable to the request comprises:
identifying, from a set of digital policies maintained by the computer system, a digital policy configured with a rule referring to the one or more tags and the one or more attributes of the request as logical conditions for allowing or disallowing access to the data.

3. The method of claim 2, wherein the rule includes a tag class as an indirect reference to the one or more tags, the tag class representing a group of tags that are related according to a tag taxonomy.

4. The method of claim 1, wherein the one or more data governance policies include a masking policy, and wherein deriving the filtered data comprises masking a portion of the data in accordance with the masking policy.

5. The method of claim 1, wherein the one or more data governance policies include an authorization policy, and wherein deriving the filtered data comprises omitting a portion of the data in accordance with the authorization policy.

6. The method of claim 1, wherein deriving the filtered data comprises rewriting an initial query corresponding to the request to form a modified query for obtaining the filtered data from a datastore of the computer system.

7. The method of claim 1, further comprising:
determining the one or more tags using the data as an input to a machine learning model, a generative artificial intelligence model, or a pattern recognition algorithm;
storing the one or more tags in association with the data prior to receiving the request;
determining an initial set of tags for the data using the machine learning model, the pattern recognition algorithm, or both, wherein the initial set of tags comprises a subset of tags from a tag taxonomy; and
determining the one or more tags through inputting the initial set of tags to the generative artificial intelligence model.

8. A computer system comprising:
one or more processors; and
memory storing instructions that, when executed by the one or more processors, cause the computer system to:
receive a request from a computing device of a user for access to data available through the computer system, at least some of the data being stored locally in the computer system;
identify one or more tags associated with the data, each tag comprising a metadata label characterizing the data;
determine that one or more data governance policies are applicable to the request based on the one or more tags and further based on one or more attributes of the request;
derive filtered data through applying the one or more data governance policies to the data; and
output the filtered data to the computing device of the user in response to the request.

9. The computer system of claim 8, wherein to determine that one or more data governance policies are applicable to the request, the one or more processors are configured to identify, from a set of digital policies maintained by the computer system, a digital policy configured with a rule referring to the one or more tags and the one or more attributes of the request as logical conditions for allowing or disallowing access to the data.

10. The computer system of claim 9, wherein the rule includes a tag class as an indirect reference to the one or more tags, the tag class representing a group of tags that are related according to a tag taxonomy.

11. The computer system of claim 8, wherein the one or more data governance policies include a masking policy, and wherein deriving the filtered data comprises masking a portion of the data in accordance with the masking policy.

12. The computer system of claim 8, wherein the one or more data governance policies include an authorization policy, and wherein to derive the filtered data, the one or more processors are configured to omit a portion of the data in accordance with the authorization policy.

13. The computer system of claim 8, wherein to derive the filtered data, the one or more processors are configured to rewrite an initial query corresponding to the request to form a modified query for obtaining the filtered data from a datastore of the computer system.

14. The computer system of claim 8, wherein the instructions further cause the computer system to:
determine the one or more tags using the data as an input to a machine learning model, a generative artificial intelligence model, or a pattern recognition algorithm;
store the one or more tags in association with the data prior to receiving the request;
determine an initial set of tags for the data using the machine learning model, the pattern recognition algorithm, or both, wherein the initial set of tags comprises a subset of tags from a tag taxonomy; and
determine the one or more tags through inputting the initial set of tags to the generative artificial intelligence model.

15. A non-transitory computer-readable medium storing program code executable by one or more processors of a computer system, the program code including instructions configurable to cause:
receiving a request from a computing device of a user for access to data available through a computer system, at least some of the data being stored locally in the computer system;
identifying one or more tags associated with the data, each tag comprising a metadata label characterizing the data;
determining that one or more data governance policies are applicable to the request based on the one or more tags and further based on one or more attributes of the request;
deriving filtered data through applying the one or more data governance policies to the data; and
outputting the filtered data to the computing device of the user in response to the request.

16. The non-transitory computer-readable medium of claim 15, wherein determining that one or more data governance policies are applicable to the request comprises:
identifying, from a set of digital policies maintained by the computer system, a digital policy configured with a rule referring to the one or more tags and the one or more attributes of the request as logical conditions for allowing or disallowing access to the data.

17. The non-transitory computer-readable medium of claim 16, wherein the rule includes a tag class as an indirect reference to the one or more tags, the tag class representing a group of tags that are related according to a tag taxonomy.

18. The non-transitory computer-readable medium of claim 15, wherein the one or more data governance policies include a masking policy, and wherein deriving the filtered data comprises masking a portion of the data in accordance with the masking policy.

19. The non-transitory computer-readable medium of claim 15, wherein the one or more data governance policies include an authorization policy, and wherein deriving the filtered data comprises omitting a portion of the data in accordance with the authorization policy.

20. The non-transitory computer-readable medium of claim 15, the instructions further configurable to cause:
determining the one or more tags using the data as an input to a machine learning model, a generative artificial intelligence model, or a pattern recognition algorithm;
storing the one or more tags in association with the data prior to receiving the request;
determining an initial set of tags for the data using the machine learning model, the pattern recognition algorithm, or both, wherein the initial set of tags comprises a subset of tags from a tag taxonomy; and
determining the one or more tags through inputting the initial set of tags to the generative artificial intelligence model.
